(19) United States
(12) Patent Application Publication
(10) Pub. No.: US 2017/0132590 A1
(43) Pub. Date: May 11, 2017

(54) SYSTEMS AND METHODS FOR PROVIDING ONLINE ACCESS TO RESOURCES

(71) Applicant: JOOM3D.COM TECHNOLOGIES INCORPORATED, Vancouver (CA)

(72) Inventor: Paul D. Tinari, Vancouver (CA)

(21) Appl. No.: 15/273,583

(22) Filed: Sep. 22, 2016

Related U.S. Application Data
(60) Provisional application No. 62/222,045, filed on Sep. 22, 2015.

(51) Int. Cl. G06Q 20/10; G06F 17/30

(52) U.S. Cl. CPC G06Q 20/102; G06F 17/30327; G06F 17/30091; G06F 17/30598

(57) ABSTRACT

Methods of classifying files performed by a computing system. The methods include uploading a file from a client computing device, receiving a category identification, and associating a root node of a category tree with the file. The root node is a previous node and associated with the category identification. A number of sub-category identifications are received from the client computing device. The number was previously unknown by the computing system. For each sub-category identification, the computing system may determine whether the sub-category identification is a synonym of an existing sub-category identification associated with a child node of the previous node. When the sub-category identification is not a synonym, a linked node associated with the file and sub-category identification is created in the category tree, the linked node is associated with the previous node as a new child node, and the new child node becomes the previous node after this association.

### CROSS REFERENCE TO RELATED APPLICATION(S)

This application claims the benefit of U.S. Provisional Application No. 62/222,045, filed on Sep. 22, 2015, which is incorporated herein by reference in its entirety.

### BACKGROUND OF THE INVENTION

Field of the Invention

The present invention is directed generally to systems and methods for providing online resources to users.

Description of the Related Art

Many users obtain resources from other users over the Internet. Such resources may include files like three-dimensional model or print data files used by three-dimensional printers, drawings, photographs, music files, video files, document files, etc. With recent advances in three-dimensional printing technology and increased availability of three-dimensional printers, a need for print data files printable by these devices has emerged. Thus, a need exists for methods and systems that allow users to share files, including those created by the users themselves, with one another. Methods and systems configured to properly categorize user created files for storage and subsequent retrieval would be particularly desirable. Methods and systems configured to compensate users for their files are also desirable. The present application provides these and other advantages as will be apparent from the following detailed description and accompanying figures.

### BRIEF DESCRIPTION OF THE SEVERAL VIEWS OF THE DRAWING(S)

FIG. 1 is a block diagram of a system including a warehouse computing system configured to receive files from users and make those files available for download to other users.

FIG. 2 is a flow diagram of a method of uploading a file to the warehouse computing system of FIG. 1.

FIG. 3 is a diagram of an organizational structure that may be used by the warehouse computing system to categorize files for storage and retrieval.

FIG. 4 is a flow diagram of a method that allows a user to identify a category and, optionally, one or more sub-categories associated with a file uploaded by the method of FIG. 2.

FIG. 5 is a flow diagram of a method of purchasing and downloading a file from the warehouse computing system.

FIG. 6 is a diagram of a hardware environment and an operating environment in which the computing devices of the system of FIG. 1 may be implemented.

FIG. 7 is a flow diagram of a method of downloading an original file from the warehouse computing system, modifying the original file to create a modified file, and uploading the modified file to the warehouse computing system.

Like reference numerals have been used to identify like components in the figures.

### DETAILED DESCRIPTION OF THE INVENTION

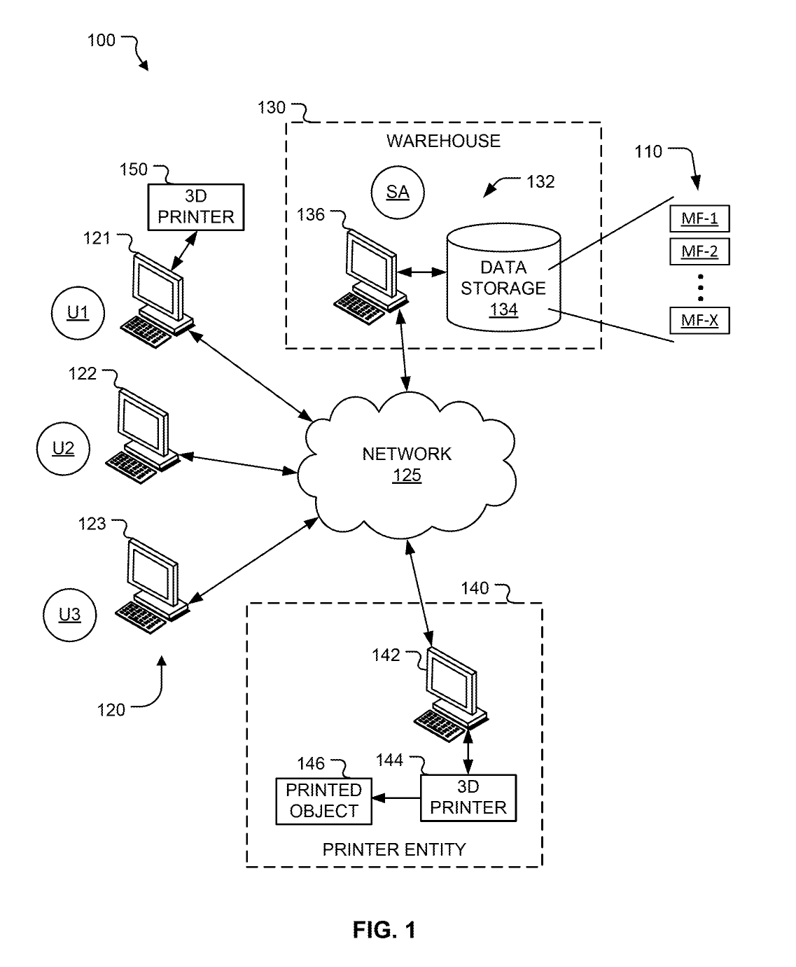

FIG. 1 depicts a system 100 configured to receive files 110 from users U1-U3 (e.g., via a website) and make those files 110 available for download (for a fee) to all of the users. By way of non-limiting examples, the files 110 may include three-dimensional model or print data files (e.g., print data files MF-1 to MF-X) printable by three-dimensional printers, drawings, photographs, music files, video files, document files, database files, spreadsheets, game files, executable files, data files, sub-combinations thereof, and the like. Using the system 100, the users U1-U3 can upload and download their own files or download files uploaded by other users. Further, the users U1-U3 can modify a previously uploaded file and upload the modified file as a new file. The files 110 may include any type of data and the system 100 is not restricted to use with any particular type of files.

The system 100 includes a plurality of client computing devices 120 operated by the users U1-U3. In the embodiment illustrated, the users U1-U3 operate client computing devices 121-123, respectively. The client computing devices 120 are connected by a network 125 (e.g., the Internet) to one another, and a warehouse computing system 132 operated by a warehouse 130. Each of the client computing devices 120 is configured to receive a web interface (e.g., web pages) from the warehouse computing system 132, display the web interface, receive user input via the web interface, and transmit that user input to the warehouse computing system 132. Each of the client computing devices 120 may include web browser configure to communicate with web server components implemented on the warehouse computing system 132.

The warehouse computing system 132 includes at least one server computer device 136 and a data storage 134 (e.g., a database). Operations of the warehouse computing system 132 may be administered at least in part by a system administrator SA. The server computer device 136 may include web server components (not shown) configured to transmit a web interface (e.g., web pages) to the client computing devices 121-123. The data storage 134 may be at least partially implemented by the server computer device 136. Optionally, the data storage 134 may be at least partially implemented by one or more other computing devices (not shown) connected to the server computer device 136.

Optionally, the client computing devices 120 are connected by the network 125 to a printer computing device 142 operated by a printer entity 140. The printer computing device 142 is connected to at least one three-dimensional (“3D”) printer 144. Each of the print data files MF-1 to MF-X contains data necessary for the 3D printer 144 to print a physical object 146 created (or designed) by one or more of the users U1-U3. Each of the client computing devices 120 is configured to download one of the print data files MF-1 to MF-X (e.g., a print data file MF-2) and transmit the print data file to the printer computing device 142, which instructs the 3D printer 144 to print the physical object 146 defined by the print data file.

Optionally, a 3D printer 150 may be connected to one or more of the client computing devices 120. For example, in FIG. 1, the 3D printer 150 is connected to the client computing device 121. In such embodiments, the client computing device 121 may download one of the print data files MF-1 to MF-X (e.g., the print data file MF-2) and instruct the 3D printer 150 to print the object defined by the print data file.

While FIG. 1 depicts the three users U1-U3 (operating the three client computing devices 121-123), the single warehouse 130 (operating the single warehouse computing system 132), the single optional printer computing device 142, and the two optional 3D printers 144 and 150, as is apparent to those of ordinary skill in the art, the system 100 may include any number of users (operating any number of client computing devices), any number of the warehouses (operating any number of warehouse computing systems), any number of optional printer computing devices, and any number of optional 3D printers.

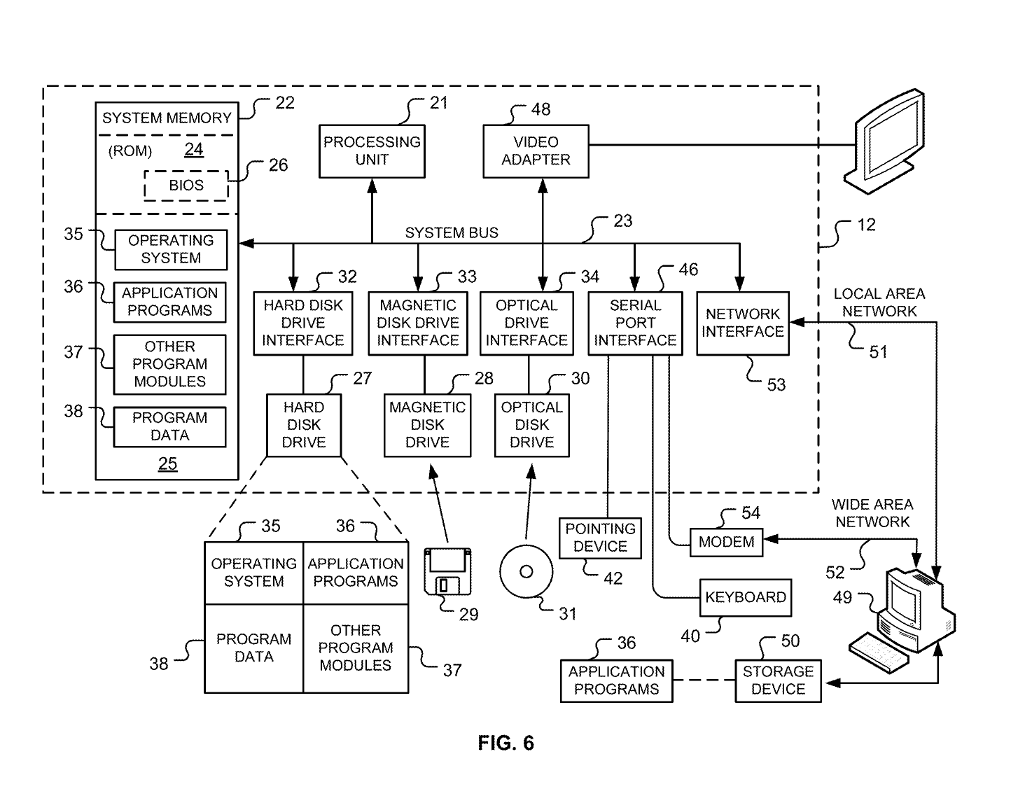

Each of the computing devices (e.g., the client computing devices 121-123, the server computer device 136, and the optional printer computing device 142) of the system 100 may be implemented by a computing device 12 described below and illustrated in FIG. 6.

By way of a non-limiting example, the system 100 may be used to provide three-dimensional print data files defining printable “replacement” parts for machines and devices that are no longer supported by the original manufacturers. As will be described below, the warehouse computing system 132 is configured to offer user-generated categories with unlimited levels of subcategories. Further, the print data files MF-1 to MF-X may be downloaded and edited by other users. Thus, the print data files MF-1 to MF-X may be characterized as being non-proprietary.

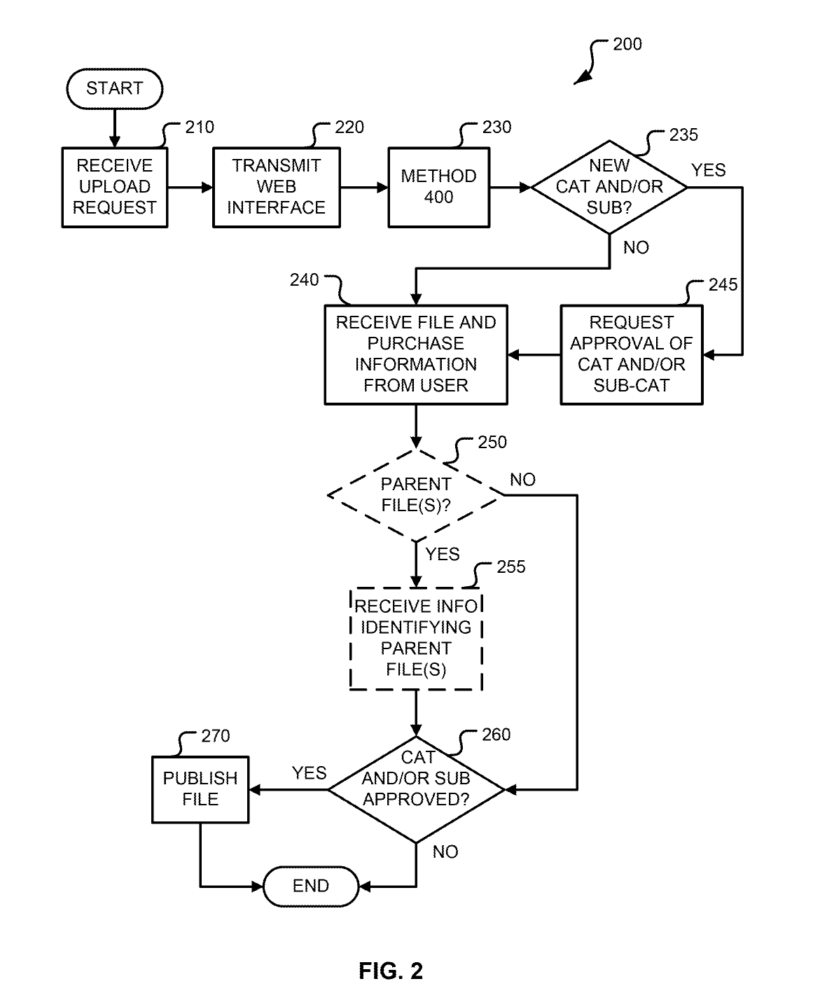

FIG. 2 is a flow diagram of a method 200 that may be performed by the warehouse computing system 132 (see FIG. 1) when one of the users U1-U3 (see FIG. 1) uploads one of the files 110 (see FIG. 1). For ease of illustration, the method 200 will be described with respect to the user U1 uploading the print data file MF-2 (see FIG. 1). However, as explained above, the files 110 may include any type of data and the method 200 is not restricted to being performed with any particular type of files.

In first block 210, the warehouse computing system 132 receives an upload request from the user U1 (via the client computing device 121). In response, in block 220, the warehouse computing system 132 transmits a web interface to the client computing device 121 that includes an upload input that the user U1 uses to identify the print data file MF-2 for upload.

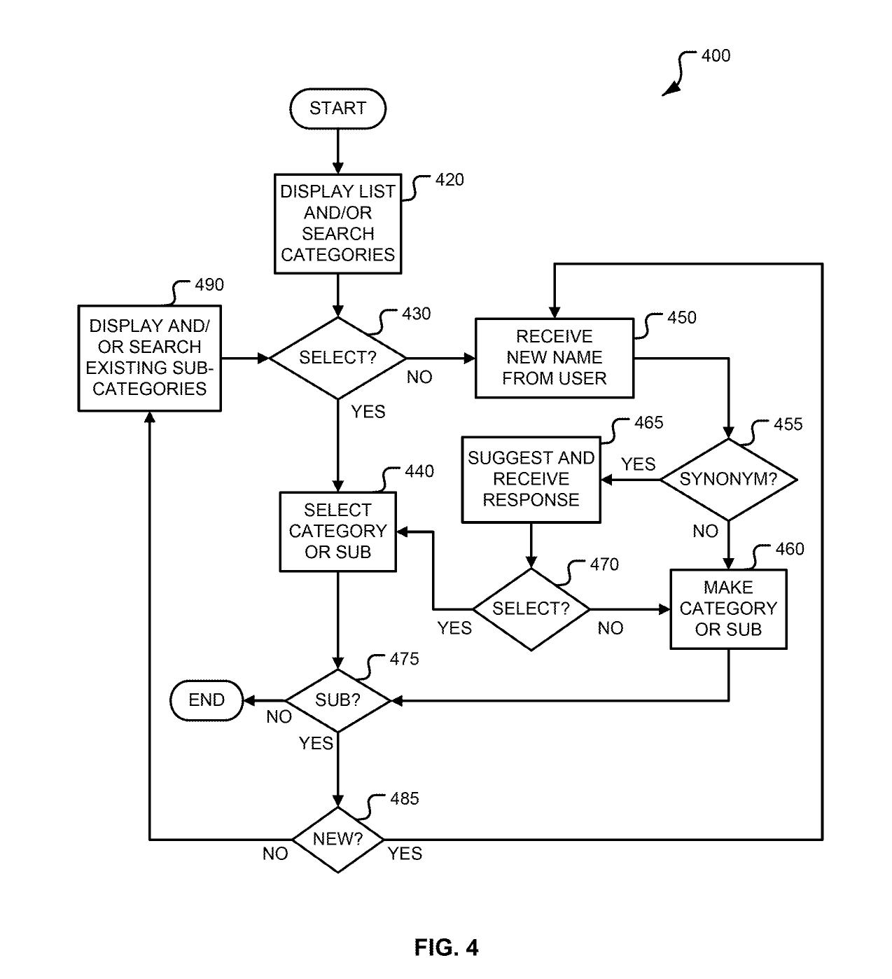

In next block 230, the warehouse computing system 132 performs a method 400 depicted in FIG. 4. The method 400 associates a category and optionally, one or more sub-categories with the file to be uploaded (e.g., the print data file MF-2) in the data storage 134 (see FIG. 1). The category and optional sub-categories are determined by the user U1. Optionally, the data storage 134 may include a separate folder for each unique category (and optionally each unique sub-category under each category). The files 110 may each be stored in the folder associated with the category (and optionally the sub-category) that is also associated with the file.

In decision block 235, the warehouse computing system 132 determines whether the user U1 created a new category and/or one or more new sub-categories in block 230. The decision in decision block 235 is “YES” when the user U1 created a new category and/or one or more new sub-categories. Otherwise, the decision in decision block 235 is “NO.”

When the decision in decision block 235 is “NO,” the warehouse computing system 132 advances to block 240. On the other hand, when the decision in decision block 235 is “YES,” in block 245, the warehouse computing system 132 requests approval of the new category and/or the one or more new sub-categories identified in block 230. The request is sent to and evaluated by the system administrator SA (see FIG. 1). The system administrator SA decides whether to approve or disapprove the request and enters that decision into the warehouse computing system 132. Then, the warehouse computing system 132 advances to block 240.

In block 240, the warehouse computing system 132 receives file and purchase information (e.g., price) from the user U1 via the web interface. The price may be entered in points (e.g., via the web interface) that may be purchased from the warehouse 130 (see FIG. 1).

In optional decision block 250, the warehouse computing system 132 receives an indication from the user U1 (via the web interface) as to whether the file being uploaded (e.g., the print data file MF-2) was created from one or more parent files. If the print data file MF-2 was created from another file (e.g., the print data file MF-1), the user U1 should indicate (via the web interface) that the print data file MF-2 has a parent file.

The decision in optional decision block 250 is “YES” when the user U1 indicates the file being uploaded (e.g., the print data file MF-2) has one or more parent files. Otherwise, the decision in optional decision block 250 is “NO.”

When the decision in optional decision block 250 is “YES,” in optional block 255, the warehouse computing system 132 receives information from the user U1 (via the web interface) identifying the one or more parent files (e.g., the print data file MF-1). Then, the warehouse computing system 132 advances to decision block 260. When the decision in decision block 250 is “NO,” the warehouse computing system 132 advances to decision block 260. If the blocks 250 and 255 are omitted from the method 200, after block 240, the warehouse computing system 132 advances to decision block 260.

In decision block 260, the warehouse computing system 132 determines whether the system administrator SA (see FIG. 1) has approved the category and any sub-categories associated with the file being uploaded (e.g., the print data file MF-2). The decision in decision block 260 is “YES” when the system administrator SA has approved the category and any sub-categories associated with the file being uploaded (e.g., the print data file MF-2). Otherwise, the decision in decision block 260 is “NO.” When the decision in decision block 260 is “NO,” the method 200 terminates without publishing the file being uploaded (e.g., the print data file MF-2). Unpublished files are not available to the users U1-U3 for download from the warehouse 130 (see FIG. 1).

On the other hand, when the decision in decision block 260 is “YES,” in block 270, the warehouse computing system 132 publishes the file being uploaded (e.g., the print data file MF-2), which makes that file available to the users U1-U3 for download.

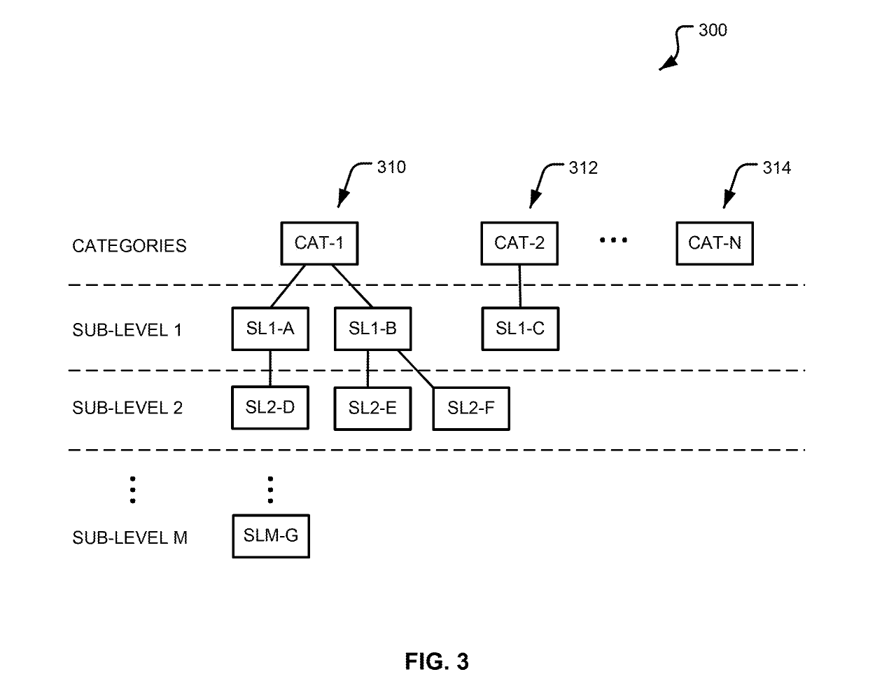

FIG. 3 is a diagram illustrating an organizational structure 300 that may be used by the warehouse computing system 132 to store data in the data storage 134. The structure 300 is used to categorize the files 110 for storage and retrieval. The structure 300 includes a plurality of infinitely expandable category trees 310-314. Each of the trees 310-314 may be characterized as having a root node representing a category, and optionally one or more linked nodes each representing a sub-category. In the example illustrated in FIG. 3, the tree 310 has a root node representing a category CAT-1, the tree 312 has a root node representing a category CAT-2, and the tree 314 has a root node representing a category CAT-N.

The example illustrated in FIG. 3 includes a number “N” of trees. The number “N” is not predetermined. Instead, the users U1-U3 create new trees each with a root node (representing a unique category) as they deem necessary when uploading the files 110. Thus, the number “N” may increase over time. A system administrator SA may delete or consolidate user created categories to reduce the number “N,” if desired.

Each of the trees 310-314 may be characterized as having a number of sub-levels that is not predetermined. The number of sub-levels may be zero and may be different for different trees 310-314. For example, the tree 310 has a number “M” of sub-levels, the tree 312 has a single sub-level, and the tree 314 has zero sub-levels. Within each of the trees 310-314, each sub-level includes one or more linked nodes (each representing a sub-category). Each linked node within a particular sub-level is linked (as a child) to a (parent) node in a level above the particular sub-level.

In FIG. 3, the tree 312 includes the first sub-level (labeled SUB-LEVEL 1) that includes a linked node SL1-C connected (as a child) to the root node (representing the category CAT-2). By way of a non-limiting example, the category CAT-2 may be “toys” and the sub-category SL1-C may be “horses. By way of another example, the tree 310 includes a first sub-level (labeled SUB-LEVEL 1) that includes linked nodes SL1-A and SL1-B both connected to the root node (representing the category CAT-1). The tree 310 also includes a second sub-level (labeled SUB-LEVEL 2) that includes a linked node SL2-D connected (as a child node) to the linked (parent) node SL1-A on the first sub-level. The second sub-level (labeled SUB-LEVEL 2) also includes linked nodes SL2-E and SL2-F both connected (as child nodes) to the linked (parent) node SL1-B on the first sub-level. Sub-levels between the second sub-level (labeled SUB-LEVEL 2) and the lowest sub-level (labeled SUB-LEVEL M) have been omitted from FIG. 3.

Within each of the trees 310-314, the users U1-U3 create the sub-levels and sub-categories within the sub-levels as they deem necessary when uploading the files 110 (see FIG. 1). Thus, the number of sub-levels and/or sub-categories associated with a particular category (represented by a root node) may increase over time. The system administrator SA (see FIG. 1) may delete or consolidate user created sub-levels within a particular tree to reduce the number associated with the same root node, if desired. The system administrator SA may delete or consolidate user created sub-categories (represented as child nodes) within the same sub-level and linked to the same parent node, if desired.

FIG. 4 is a flow diagram of a method 400 that may be performed by the warehouse computing system 132 to allow one of the users U1-U3 to identify the category and, optionally, sub-categories associated with the file being uploaded (e.g., the print data file MF-2) by the method 200. For ease of illustration, the method 400 will be described with respect to the user U1 uploading the print data file MF-2. However, as explained above, the files 110 may include any type of data and the method 400 is not restricted to being performed with any particular type of files.

In first block 420, the warehouse computing system 132 instructs the client computing device 121 to display (via the web interface) a list of categories or a search option that the user U1 may use to search for a particular category. Using the web interface, the user U1 either indicates that (a) the user U1 would like to select a category (e.g., from the list or in the search results) or (b) the user U1 would like to create a new category. The warehouse computing system 132 may prompt the user U1 to create a new category if the list is empty or a search for the category did not return any results.

In decision block 430, the warehouse computing system 132 determines whether the user U1 indicated the user U1 would like to select a category or sub-category (as appropriate). The first time decision block 430 is visited after block 420, the user U1 indicated whether the user U1 would like to select a category. After the first visit, the user U1 indicated whether the user U1 would like to select a sub-category. The decision in decision block 430 is “YES” when the user U1 indicated that the user U1 would like to select a category or a sub-category (as appropriate). When the decision in decision block 430 is “YES,” the warehouse computing system 132 advances to block 440. On the other hand, the decision in decision block 430 is “NO” when the user U1 indicated that the user U1 would like to create a new category sub-category (as appropriate). When the decision in decision block 430 is “NO,” the warehouse computing system 132 advances to block 450.

In block 440, the warehouse computing system 132 associates the category or sub-category (as appropriate) selected by the user U1 with the file being uploaded (e.g., the print data file MF-2). When a category is selected, an existing root node (representing the category selected) of an existing tree is associated with the print data file MF-2. On the other hand, when a sub-category is created, a new linked node (representing the new sub-category) is created in the tree associated with the print data file MF-2. The new linked node is associated with (or linked to) a parent node in the tree associated with the print data file MF-2. The parent node may be either the root node or an existing linked node in a level above the new linked node in the tree associated with the print data file MF-2. Optionally, the new category or sub-category may require approval from the system administrator SA, which is requested in block 245 of the method 200 (see FIG. 2).

In block 450, the warehouse computing system 132 receives a name (and optionally other information) for the new category or sub-category (as appropriate) from the user U1 (via the web interface).

In decision block 455, the warehouse computing system 132 determines whether the name received in block 450 is a synonym. When the name received in block 450 is the name of a category, in decision block 455, the warehouse computing system 132 determines whether the name received is a synonym of an existing category. On the other hand, when the name received in block 450 is the name of a sub-category, in decision block 455, the warehouse computing system 132 determines whether the name received is a synonym of an existing sub-category linked to the same parent node. The decision in decision block 455 is “NO” when the name received is not a synonym. When the decision in decision block 455 is “NO,” the warehouse computing system 132 advances to block 460. On the other hand, the decision in decision block 455 is “YES” when the name received is a synonym. When the decision in decision block 455 is “YES,” the warehouse computing system 132 advances to block 465.

In block 460, the warehouse computing system 132 creates the new category or sub-category, as appropriate. When a new category is created, a new root node (representing the new category) of a new tree is created and associated with the file being uploaded (e.g., the print data file MF-2). On the other hand, when a new sub-category is created, a new linked node (representing the new sub-category) is created in the tree associated with the file being uploaded (e.g., the print data file MF-2). The new linked node is associated with (or linked to) a parent node in the tree associated with the file being uploaded (e.g., the print data file MF-2). The parent node may be either the root node or an existing linked node in a level above the new linked node in the tree associated with the file being uploaded (e.g., the print data file MF-2). Optionally, the new category (or sub-category) may require approval from the system administrator SA, which is requested in block 245 of the method 200 (see FIG. 2).

In block 465, the warehouse computing system 132 suggests (via the web interface) that the user U1 select the synonym category or sub-category (as appropriate) and receives a response (via the web interface) from the user U1.

The decision in decision block 470 is “YES” when the user U1 decided to use the synonym category or sub-category. Otherwise, the decision in decision block 470 is “NO.”

When the decision in decision block 470 is “NO,” the warehouse computing system 132 advances to block 460. After block 460, the warehouse computing system 132 advances to decision block 475.

When the decision in decision block 470 is “YES,” the warehouse computing system 132 advances to block 440. After block 440, the warehouse computing system 132 advances to decision block 475.

At decision block 475, the warehouse computing system 132 receives an indication as to whether the user U1 would like to associate a sub-category with the file being uploaded (e.g., the print data file MF-2). The decision in decision block 475 is “YES” when the user U1 indicated that the user U1 would like to associate a sub-category with the file being uploaded (e.g., the print data file MF-2). Otherwise, the decision in decision block 475 is “NO.”

When the decision in decision block 475 is “NO,” the method 400 terminates.

When the decision in decision block 475 is “YES,” the warehouse computing system 132 determines at decision block 485 whether the user U1 previously made a new category (or sub-category) in block 460. If the user U1 created a new category or sub-category, no exiting sub-categories (which would be a level below the newly created category or sub-category) will be associated therewith. Thus, the only option available to the user U1 is to create a new sub-category. The decision in decision block 485 is “YES,” when the user U1 previously made a new category (or sub-category) in block 460. Otherwise, the decision in decision block 485 is “NO.”

When the decision in decision block 485 is “YES,” the warehouse computing system 132 returns to block 450 to receive the name of the new sub-category. Then, the method 400 progresses with respect the newly received name for the new sub-category.

When the decision in decision block 485 is “NO,” the warehouse computing system 132 advances to block 490 whereat the warehouse computing system 132 instructs the client computing device 121 to display a list of sub-categories (that are children of the previously selected or created category or sub-category) or includes a search function that the user U1 may use to search for a particular sub-category (within the children of the previously selected or created category or sub-category). Using the web interface, the user U1 either indicates that (a) the user U1 would like to select an existing sub-category (e.g., from the list or in the search results) or (b) the user U1 would like to create a new sub-category. The warehouse computing system 132 may prompt the user U1 to create a new sub-category if the list is empty or the search did not return any results. Then, the warehouse computing system 132 returns to decision block 430.

The method 400 may be characterized as creating a user-generated, infinitely expandable category system that allows the users U1-U3 to upload files to the warehouse computing system 132, which stores and properly organizes the files. The method 400 may be used to create user-generated categories and infinite sub-levels of sub-categories. For example, the method 400 may be performed multiple times (e.g., each time one of the files 110 is uploaded) to construct the trees 310-314 (see FIG. 3).

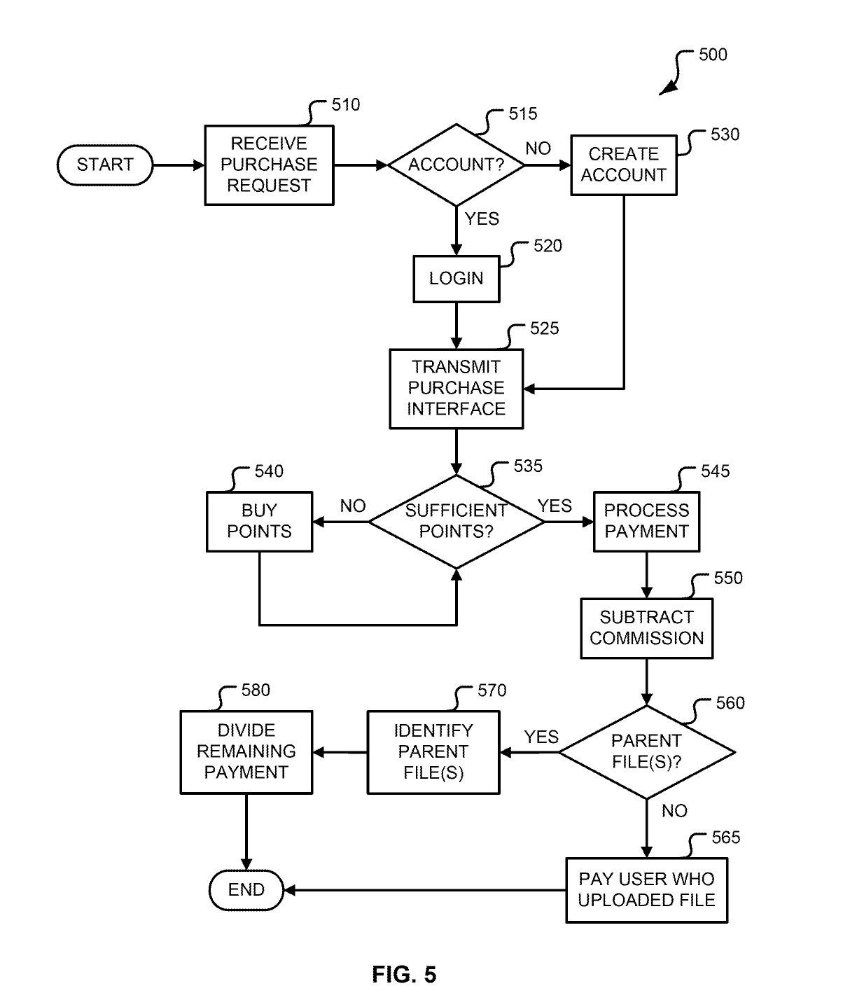

FIG. 5 is a flow diagram of a method 500 that may be performed by the warehouse computing system 132 when one of the users U1-U3 purchases and downloads one of the files 110. For ease of illustration, the method 500 will be described with respect to the user U2 purchasing and downloading the print data file MF-2. However, as explained above, the files 110 may include any type of data and the method 500 is not restricted to being performed with any particular type of files.

In first block 510, the warehouse computing system 132 receives a purchase request from the user U2 (via the web interface) identifying the file being purchased (e.g., the print data file MF-2).

At decision block 515, the warehouse computing system 132 determines whether the user U2 has an account with the warehouse 130. The decision in decision block 515 is “YES,” when the user U2 has an account with the warehouse 130. Otherwise, the decision in decision block 515 is “NO.”

When the decision in decision block 515 is “YES,” in block 520, the warehouse computing system 132 receives login information from the user U2 and after successfully verifying the user U2, advances to block 525.

When the decision in decision block 515 is “NO,” in block 530, the warehouse computing system 132 requests new account information from the user U2 and creates a new account for the user U2. Then, the warehouse computing system 132 advances to block 525.

In block 525, the warehouse computing system 132 transmits a purchase web interface (e.g., a web page) to the client computing device 122. The client computing device 122 displays the purchase web interface to the user U2. The purchase web interface may include one or more purchase inputs that the user U2 may use to input purchase information and submit that information to the warehouse computing system 132.

At decision block 535, the warehouse computing system 132 determines whether the user U2 has a sufficient number of points to purchase the file (e.g., the print data file MF-2) identified in the purchase request received in block 510. The decision in decision block 535 is “YES” when the user U2 has a sufficient number of points to purchase the file (e.g., the print data file MF-2) identified in the purchase request received in block 510. Otherwise, the decision in decision block 535 is “NO.”

When the decision in decision block 535 is “NO,” in block 540, the warehouse computing system 132 sells additional points to the user U2. Then, the warehouse computing system 132 returns to decision block 535.

When the decision in decision block 535 is “YES,” in block 545, the warehouse computing system 132 processes the payment (e.g., debits the account of the user U2) and downloads the file (e.g., the print data file MF-2) identified in the purchase request (received in block 510) to the user U2.

In block 550, the warehouse computing system 132 subtracts a commission (e.g., 20%) from the payment and credits the commission to an account controlled by the warehouse 130.

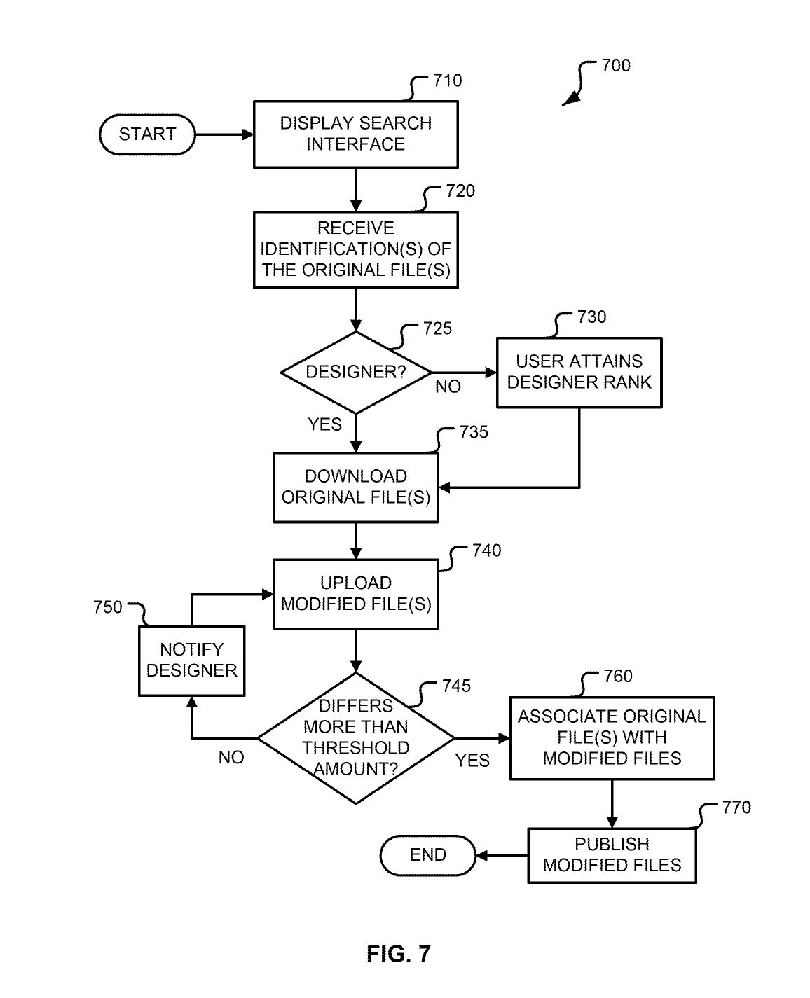

At decision block 560, the warehouse computing system 132 determines whether the file (e.g., the print data file MF-2) identified in the purchase request (received in block 510) has at least one parent file (e.g., identified by the user U1 in block 255 of the method 200 illustrated in FIG. 2, or identified using a method 700 illustrated in FIG. 7). The decision in decision block 560 is “YES,” when the file (e.g., the print data file MF-2) identified in the purchase request (received in block 510) has at least one parent file. Otherwise, the decision in decision block 560 is “NO.”

When the decision in decision block 560 is “NO,” in block 565, the warehouse computing system 132 credits the remainder (e.g., 80%) of the payment to the account associated with the user (e.g., the user U1) who uploaded the file (e.g., the print data file MF-2) identified in the purchase request received in block 510. Then, the method 500 terminates.

In the example above, the print data file MF-2 has a parent file, namely the print data file MF-1. Thus, in this example, the decision in decision block 560 would be “YES.” When the decision in decision block 560 is “YES,” in block 570, the warehouse computing system 132 identifies any parents of the print data file MF-2. In the example mentioned above, the warehouse computing system 132 would identify the print data file MF-1. If the print data file MF-1 (or any other parents of the print data file MF-2) also had a parent file, in block 570, the warehouse computing system 132 also identifies those parent files.

Then, in block 580, the warehouse computing system 132 divides the remaining payment between the user U1 who uploaded the file (e.g., the print data file MF-1) identified in the purchase request (received in block 510) and the user(s) who uploaded each of the parent files identified in block 570. By way of a non-limiting example, the remaining payment may be divided evenly between these parties. In the example, if there is only a single parent file, the parties would each receive 50% of the remaining payment (or 40% of the entire payment when the commission is 20%). Similarly, if there are three parent files, the parties would each receive 20% of the entire payment when the commission is 20%. Then, the method 500 terminates.

Referring to FIG. 1, in some embodiments, some of the users U1-U3 may be ranked or classified as being “Designers.” A Designer is authorized to download and modify the three-dimensional model or print data files (e.g., the print data files MF-1 to MF-X illustrated in FIG. 1) stored by the warehouse computing system 132. FIG. 7 is a flow diagram of the method 700 that may be performed by the warehouse computing system 132 when a Designer wishes to download and modify one or more files. For ease of illustration, the method 700 will be described with respect to the user U2 who wishes to download and modify an original file (e.g., a three-dimensional model or print data file).

In first block 710, the warehouse computing system 132 instructs the client computing device 122 to display a search interface. The user U2 uses the search interface to identify the original file. Then, in block 720, the warehouse computing system 132 receives the identification of the original file from the client computing device 122.

In decision block 725, the warehouse computing system 132 determines whether the user U2 is a Designer (or has a higher rank). The decision in decision block 725 is “YES” when the user U2 is a Designer (or has a higher rank). Otherwise, the decision in decision block 725 is “NO.”

When the decision in decision block 725 is “NO,” in block 730, the warehouse computing system 132 allows the user U2 to fulfill the requirements to attain the rank of “Designer.” Then, the warehouse computing system 132 advances to block 735.

When the decision in decision block 725 is “YES,” the warehouse computing system 132 advances to block 735. In block 735, the warehouse computing system 132 downloads the original file to the user U2. At this point, the user U2 modifies the original file to create a modified file. Then, in block 740, the warehouse computing system 132 uploads the modified file (e.g., from the client computing device 122).

In decision block 745, the warehouse computing system 132 determines whether the modified file differs from the original file by more than a threshold amount (e.g., more than 20%). The decision in decision block 745 is “YES” when the modified file differs from the original file by more than the threshold amount. Otherwise, the decision in decision block 745 is “NO.”

When the decision in decision block 745 is “NO,” in block 750, the warehouse computing system 132 notifies the user U2 that the modified file will not be published because the modified file is not sufficiently different enough from the original file. At this point, the user U2 may make additional modifications to the modified file and upload the modified file again in block 740.

When the decision in decision block 745 is “YES,” in block 760, the warehouse computing system 132 associates the modified file with the original file and identifies the original file as a parent of the modified file. The method 400 (see FIG. 4) may also be performed in block 760 to associate the modified file with a category and, optionally, one or more sub-categories.

Next, in block 770, the warehouse computing system 132 publishes the modified file. Then, the method 700 terminates. At this point, one of the users U1-U3 has uploaded the original file to the warehouse computing system 132, the user U2 has downloaded the original file, the user U2 has modified (e.g., improved) the original file, and the user U2 has re-posted the modified file to the warehouse computing system 132 (which publishes the modified file for download by the users U1-U3). Additionally, the warehouse computing system 132 tracks the number of parent files associated with the original file for the purposes of dividing the payment amount in block 580 of the method 500 illustrated in FIG. 5.

### Computing Device

FIG. 6 is a diagram of hardware and an operating environment in conjunction with which implementations of the one or more computing devices of the system 100 may be practiced. The description of FIG. 6 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 6 includes a general-purpose computing device in the form of the computing device 12. Each of the computing devices of FIG. 1 (including the client computing devices 121-123, the server computer device 136, and the printer computing device 142) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 6 include a local-area network (LAN) 51 and a wide-area network (WAN) 52. Such networking environments are commonplace in offices, enterprise-wide computer networks, intranets and the Internet. The network 125 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 200, 400, 500, and 700 illustrated in FIGS. 2, 4, 5, and 7, respectively) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean at least one” or one or more“); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method of constructing a category tree of a data structure, the method comprising:
uploading, by a computing system, a file from a client computing device operated by a user;
receiving, by the computing system, a category identification from the client computing device;
associating, by the computing system, a root node of the category tree with the file, the root node being associated with the category identification, the root node being a previous node;
receiving, by the computing system, a number of sub-category identifications from the client computing device, the sub-category identifications having been provided by the user and the number being previously unknown by the computing system; and
for each of the sub-category identifications,
(a) determining, by the computing system, whether the sub-category identification is a synonym of an existing sub-category identification associated with a child node of the previous node, and
(b) when the computing system determines the sub-category identification is not a synonym, (i) creating, by the computing system, a linked node associated with the sub-category identification in the category tree, (ii) associating, by the computing system, the file with the linked node, and (iii) associating, by the computing system, the linked node with the previous node as a new child node in the category tree, the new child node becoming the previous node after this association.

2. The method of claim 1, wherein the file is a three-dimensional model or print data file that is printable by a three-dimensional printer, and the method further comprises:
receiving, by the computing system, purchase information;
associating, by the computing system, the purchase information with the file; and
publishing, by the computing system, the file for purchase and download by other users.

3. The method of claim 1, wherein the user is a first user, and the method further comprises:
receiving, by the computing system, an indication that the file was created from a parent file, the parent file having been created by a different second user;
receiving, by the computing system, a purchase request for the file from a different third user;
receiving, by the computing system, a payment amount from the third user;
downloading, by the computing system, the file to the third user; and
dividing, by the computing system, the payment amount between the first and second users.

4. The method of claim 1, further comprising:
requesting, by the computing system, approval from a system administrator before creating the linked node, and
waiting, by the computing system, to create the linked node until after the approval is received.

5. The method of claim 1, wherein the computing system suggests to the user that the user select the synonym in place of the sub-category identification when the computing system determines the sub-category identification is a synonym, and
the file is associated with the child node associated with the synonym when the user selects the synonym in place of the sub-category.

6. The method of claim 1, further comprising:
creating, by the computing system, the root node.

7. The method of claim 6, further comprising:
requesting, by the computing system, approval from a system administrator before creating the root node, and
waiting, by the computing system, to create the root node until after the approval is received.

8. The method of claim 1, further comprising:
instructing, by the computing system, the client computing device to display a list including category identifications, wherein the category identification is selected from the list.

9. The method of claim 1, further comprising:
prompting, by the computing system, the user to provide the category identification to the client computing device which transmits the category identification to the computing system.

10. A computer-implemented method of classifying a file, the method comprising:
uploading, by a computing system, the file from a client computing device operated by a user;
receiving, by the computing system, a category identification from the client computing device;
associating, by the computing system, a root node of a category tree with the file, the root node being associated with the category identification, the root node being a previous node; and
until the user provides an indication that classification of the file is completed,
when the previous node is associated with one or more child nodes, instructing, by the computing system, the client computing device to display a set of sub-category identifications associated with the one or more child nodes,
when the previous node is not associated with one or more child nodes, instructing, by the computing system, the client computing device to request a new sub-category identification,
receiving either a selection of one of the set of sub-category identifications or the new sub-category identification from the client computing device, and
when the selection is received, associating a selected one of the one or more child nodes with the file, the selected child node being associated with the selected sub-category identification, the selected child node becoming the previous node, and
when the new sub-category identification is received, creating a new child node in the category tree that is associated with both the file and the previous node, the new child node becoming the previous node.

11. The method of claim 10, wherein the file is a three-dimensional model or print data file that is printable by a three-dimensional printer, and the method further comprises:
receiving, by the computing system, purchase information;
associating, by the computing system, the purchase information with the file; and
publishing, by the computing system, the file for purchase and download by other users.

12. The method of claim 10, wherein the user is a first user, and the method further comprises:
receiving, by the computing system, an indication that the file was created from a parent file, the parent file having been created by a different second user;
receiving, by the computing system, a purchase request for the file from a different third user;
receiving, by the computing system, a payment amount from the third user;
downloading, by the computing system, the file to the third user; and
dividing, by the computing system, the payment amount between the first and second users.

13. The method of claim 10, further comprising:
requesting, by the computing system, approval from a system administrator before creating the new child node, and
waiting, by the computing system, to create the new child node until after the approval is received.

14. The method of claim 10, further comprising:
creating, by the computing system, the root node.

15. The method of claim 14, further comprising:
requesting, by the computing system, approval from a system administrator before creating the root node, and
waiting, by the computing system, to create the root node until after the approval is received.

16. The method of claim 10, further comprising:
instructing, by the computing system, the client computing device to display a list including category identifications, wherein the category identification is selected from the list.

17. The method of claim 10, further comprising:
prompting, by the computing system, the user to provide the category identification to the client computing device which transmits the category identification to the computing system.
